(19) United States
(12) Patent Application Publication
(10) Pub. No.: US 2026/0113281 A1
(43) Pub. Date: Apr. 23, 2026

(54) METHOD AND DEVICE FOR SENDING DATA PACKETS, ELECTRONIC DEVICE AND READABLE STORAGE MEDIUM

(71) Applicant: Beijing Xiaomi Mobile Software Co., Ltd., Beijing (CN)

(72) Inventors: Yanhua LI, Beijing (CN); Yumin WU, Beijing (CN); Xiaowei JIANG, Beijing (CN)

(21) Appl. No.: 19/115,064

(22) PCT Filed: Sep. 29, 2022
(86) PCT No.: PCT/CN2022/122935

§ 371 Date: Mar. 25, 2025

(51) Int. Cl. H04L 47/32; H04W 28/06

(52) U.S. Cl. CPC H04L 47/32; H04W 28/06

(57) ABSTRACT

A method for sending data packets, including: discarding at least one data packet in a process of sending the data packets to a second electronic device.

### CROSS-REFERENCE TO RELATED APPLICATIONS

The present application is a U.S. National Stage of International Application No. PCT/CN2022/122935, filed on Sep. 29, 2022, the contents of all of which are incorporated herein by reference in their entireties for all purposes.

### BACKGROUND OF THE INVENTION

Currently, a reordering timer is initiated at a receiving side of a packet data convergence protocol (PDCP) layer to wait for non-continuous data messages to arrive. When data messages are discontinuously received and the reordering timer has been initiated in the PDCP layer of a user equipment, the reordering timer may expire.

### SUMMARY OF THE INVENTION

The present disclosure relates to the technical field of data transmission, in particular to a method and device for sending data packets, an electronic device and a readable storage medium.

A method and device for sending data packets, an electronic device and a readable storage medium are provided in the present disclosure.

In a first aspect, a method for sending the data packets is provided. The method is performed by a first electronic device and includes:
discarding at least one data packet in a process of sending the data packets to a second electronic device.

In a second aspect, an electronic device is provided. The electronic device includes one or more processors and a memory, where
the memory is configured to store a computer program; and
the computer program, when collectively executed by the one or more processors, causes the one or more processors to:
discard at least one data packet in a process of sending the data packets to a second electronic device.

In a third aspect, a non-transitory computer-readable storage medium is provided, where instructions are stored in the non-transitory computer-readable storage medium, and the instructions, when executed by a computer, cause the computer to:
discard at least one data packet in a process of sending the data packets to a second electronic device.

It should be understood that the above general description and the following detailed description are only examples and interpretations, and cannot limit the present disclosure.

### BRIEF DESCRIPTION OF DRAWINGS

The accompanying drawings described here are used to provide a further understanding of the embodiments of the present disclosure and constitute a part of the present disclosure, and examples and descriptions of the embodiments of the present disclosure are intended to explain the embodiments of the present disclosure and do not constitute an undue limitation of the embodiments of the present disclosure. In the drawings:

The accompanying drawings here are incorporated into and constitute a part of the description, illustrate the embodiments consistent with the embodiments of the present disclosure and together with the description, serve to explain the principles of the embodiments of the present disclosure.

FIG. 1 is a flowchart of a method for sending data packets according to an embodiment of the present disclosure;

FIG. 2 is a flowchart of another method for sending the data packets according to an embodiment of the present disclosure;

FIG. 3 is a flowchart of another method for sending the data packets according to an embodiment of the present disclosure;

FIG. 4 is a flowchart of another method for sending the data packets according to an embodiment of the present disclosure;

FIG. 5 is a structure diagram of a device for sending the data packets according to an embodiment of the present disclosure; and

FIG. 6 is a structure diagram of an electronic device according to an embodiment of the present disclosure.

### DETAILED DESCRIPTION OF THE INVENTION

Embodiments of the present disclosure will now be further described with reference to the accompanying drawings and detailed description.

Examples will be described in detail here, the instances of which are shown in the drawings. When the following description relates to the drawings, the same numbers in different drawings represent the same or similar elements unless otherwise indicated. The embodiments described in the following examples do not represent all embodiments consistent with the embodiments of the present disclosure. On the contrary, they are only examples of devices and methods consistent with some aspects of the present disclosure as detailed in the appended claims.

Currently, a reordering timer is initiated at a receiving side of a packet data convergence protocol (PDCP) layer to wait for non-continuous data messages to arrive. When data messages are discontinuously received and the reordering timer has been initiated in the PDCP layer of a user equipment, the reordering timer may expire. At that point, if a continuous message has not yet been received, the user equipment will, according to a current processing method, deliver all out-of-order data packets that have been received up to the expiration of the reordering timer to an upper layer and update a value of RX_DELIV. RX_DELIV represents a count value of a first data packet that the PDCP layer expects to deliver to the upper layer.

When a data packet, such as a packet data unit (PDU) or a service data unit (SDU) is transceived via the PDCP, continuously arriving data packets are monitored by the reordering timer, to determine whether continuous data packets that need to be received are accurately received. The continuously arriving data packets may be data packets whose sequence numbers for identifying the data packets are continuous. If the reception of the continuous data packets that need to be received is completed before the reordering timer expires, a current reordering timer is cancelled and received data packets are delivered to a target location. According to relevant conditions, next reordering timing is waited to be initiated. If continuous data packets that need to be received fail to be completely received when the reordering timer expires, continuous data packets received before and after the unreceived data packets are delivered to the target location. And, next reordering timing is waited to be initiated according to the relevant conditions. If the continuous data packets are no longer transceived via the PDCP after the reordering timer is cancelled or expires, then the reordering timer is no longer initiated.

A reordering timer is only for determining whether there are discontinuously arriving data packets in a transceiving process of continuous data packets. It does not take into account an association relationship between continuously transceived data packets and a processing manner of data packets having the association relationship during the transceiving process.

In a related service, such as an extended reality (XR) service, data packets that need to be sent continuously may be referred to as a packet set, where the packet set contains a plurality of data packets. There is certain correlation between the data packets in the packet set, e.g., some data packets are distinguished according to the importance. For example, some data packets are more important, and decoding is performed by a receiving side only when the important data packets are received, or sometimes the decoding is performed when all data packets are received. Thus, for the receiving side, in a case that the decoding is completed when the important data packets or all needed data packets are received, if the important data packets or the all data packets are not received in a packet set that needs to be received, other data packets in the packet set that needs to be received do not need to be received. From the perspective of the sending side, the other data packets in the packet set do not need to be sent, so that the unnecessary transmission overhead for the air interface is reduced. At the same time, different packet sets may also have a certain correlation. For example, if all data packets in a previous packet set are not received in the packet set that needs to be received, then all data packets in the packet set that needs to be received do not need to be received. From the perspective of the sending side, all data packets in the packet set do not need to be sent, so that the unnecessary transmission overhead for the air interface is reduced.

In view of this, in an example of the present disclosure, by considering the association relationship that may exist between the continuously transceived data packets, a method for sending the data packets is provided. The method is performed by a first electronic device, as shown in FIG. 1, FIG. 1 shows the method for sending the data packets provided by an example of the present disclosure.

Step S101, at least one data packet is discarded in a process of sending the data packets to a second electronic device.

In the example of the present disclosure, in order to efficiently send the data packets, at least one data packet is discarded according to a sending status of the data packets in the process of sending the data packets to the second electronic device. For example, during sending of the data packets, when one of the data packets failed to be sent, it may be determined that the corresponding data packet is discarded according to a status of the data packet that failed to be sent.

In the example of the present disclosure, by discarding the at least one data packet based on a sending status of the data packets in a process of data sending, invalid sending of the data packets or invalid processing of received data by a receiving side is avoided, and the processing efficiency of data packet sending is improved.

A method for sending the data in the example of the present disclosure may be configured by a base station to be valid for all radio bearers (RBs) of a terminal, or may be valid for only part of RBs. That is, it is possible to select to perform the operation of discarding associated data packets mentioned in the present disclosure only for a packet data convergence protocol (PDCP) of the part of RBs.

As an embodiment, the base station may explicitly indicate a user equipment (UE) to perform the operation on all RBs, or may explicitly indicate the UE to perform the operation on the part of RBs. For example, indication bit information is given.

As an embodiment, the base station may implicitly indicate the UE to perform the operation on all RBs, or may implicitly indicate the UE to perform the operation on the part of RBs. For example, indication bit information is given. If, for example, a discard policy is notified, it means implicit validity.

In an example of the present disclosure, by considering the association relationship that may exist between the continuously transceived data packets, a method for sending the data packets is provided. The method is performed by a first electronic device and includes at least one of:
discarding a data packet that failed to be sent to the second electronic device or discarding a data packet that has an association relationship with the data packet that failed to be sent to the second electronic device in the process of sending the data packets to the second electronic device.

In a case that the data packets are sent to the second electronic device, when a data packet failed to be sent, the data packet that failed to be sent may be selected to be discarded; the data packet that has the association relationship with the data packet that failed to be sent may also be selected to be discarded according to correlation between the data packet that failed to be sent and other data packets in a packet set where the data packet that failed to be sent is located; or the data packet that failed to be sent and the data packet that has the association relationship with the data packet that failed to be sent may also be simultaneously discarded, according to the correlation between the data packet that failed to be sent and other data packets in the packet set where the data packet that failed to be sent is located.

In a case that the data packets are sent to the second electronic device, when a data packet failed to be sent, the data packet that failed to be sent may be selected to be discarded; or the data packet that has the association relationship with the data packet that failed to be sent may also be selected to be discarded, according to correlation between the data packet that failed to be sent and other packet sets, or between the data packet that failed to be sent and data packets in other data packet set.

In a case that the data packet that has the association relationship with the data packet that failed to be sent is discarded, the data packet having the association relationship may be a packet data convergence protocol service data unit (PDCPSDU) or a related PDCP Data protocol data unit (PDU).

As an embodiment, a data packet that has not been numbered after data from a higher layer is received at a PDCP layer is the PDCPSDU.

As an embodiment, a data packet that has been numbered and waits to be sent after the data from the higher layer is received at the PDCP layer is the PDCP Data PDU.

If a related data packet has been submitted to a bottom layer, the bottom layer (radio link control (RLC) and/or medium access control (MAC)) also needs to be informed to delete the data packet having the association relationship.

In a case that the data packet that has the association relationship with the data packet that failed to be sent is discarded, if the data packet having the association relationship has not been sent, i.e., at the first electronic device, the data packet that failed to be sent and the data packet that has the association relationship with the data packet that failed to be sent are discarded by the first electronic device. If the data packet that has the association relationship with the data packet that failed to be sent has been sent to the second electronic device, i.e., a receiving side. The data packet that failed to be sent is discarded by the first electronic device while indicating the second electronic device to discard the data packet that has the association relationship with the data packet that failed to be sent, to avoid invalid processing of the received data packets by the receiving side.

For example, during sending of the data packets based on the PDCP, when a reordering timer expires or it is confirmed that a data packet has failed to be sent, at least one of the data packet that failed to be sent or the data packet that has the association relationship with the data packet that failed to be sent may be discarded.

In the example of the present disclosure, in the process of sending the data packets, when a data packet failed to be sent, at least one of the data packet that failed to be sent or the data packet that has the association relationship with the data packet that failed to be sent can be discarded, due to considering the association relationship between the data packet that failed to be sent and other data packets in the packet set where the data packet that failed to be sent is located. Therefore, unnecessary sending in the process of sending the data packets and the subsequent unnecessary data packet processing process are effectively avoided.

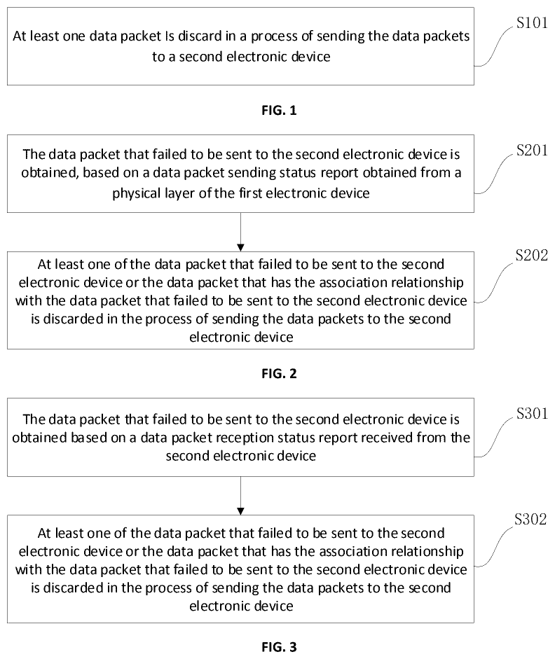

In an example of the present disclosure, by considering the association relationship that may exist between the continuously transceived data packets, the method for sending the data packets is provided. The method is performed by the first electronic device and as shown in FIG. 2, the method includes:
step S201, the data packet that failed to be sent to the second electronic device is obtained, based on a data packet sending status report obtained from a physical layer of the first electronic device.
Step S202, at least one of the data packet that failed to be sent to the second electronic device or the data packet that has the association relationship with the data packet that failed to be sent to the second electronic device is discarded in the process of sending the data packets to the second electronic device.

In a case that the data packets are sent to the second electronic device by the first electronic device, a data packet sending status is recorded in a physical layer of the first electronic device. For example, in the physical layer of the first electronic device, whether a maximum number of a hybrid automatic repeat request (HARQ) is reached is stored. If an acknowledged mode (AM) is set in a radio link control layer (RLC) of the first electronic device, the physical layer of the first electronic device triggers a plurality of retransmissions of the data packets that need to be transmitted, and it is determined that the data packet transmission has failed in a case that the number of retransmissions reaches a maximum value. Thus, information about whether the data packet transmission reaches the maximum number of times may be obtained from the physical layer of the first electronic device, to determine whether the data packet fails to be transmitted.

By obtaining the information about whether the data packet transmission reaches the maximum number of times from the physical layer of the first electronic device, it can be accurately determined whether the data packet fails to be transmitted.

In an example of the present disclosure, by considering the association relationship that may exist between the continuously transceived data packets, a method for sending the data packets is provided. The method is performed by the first electronic device and as shown in FIG. 3, the method includes:
step S301, the data packet that failed to be sent to the second electronic device is obtained based on a data packet reception status report received from the second electronic device.
Step S302, at least one of the data packet that failed to be sent to the second electronic device or the data packet that has the association relationship with the data packet that failed to be sent to the second electronic device is discarded in the process of sending the data packets to the second electronic device.

In a case that the data packets sent by the first electronic device are received by the second electronic device, if the acknowledged mode (AM) is set in the radio link control (RLC) layer of the second electronic device, the second electronic device records whether the data packet sent by the first electronic device fails to be sent. The data packet reception status report may be obtained from the second electronic device to accurately determine whether the data packet fails to be sent.

In some possible embodiments, step S300, sending trigger information to the second electronic device, where the trigger information is configured to trigger the second electronic device to send the data packet reception status report to the first electronic device is also included before Step S301.

To obtain the data packet reception status report from the second electronic device, the trigger information may be sent to the second electronic device to cause the second electronic device to send the data packet reception status report to the first electronic device. The trigger information may be any information, such as polling information sent by the first electronic device to the second electronic device.

The trigger information may include any information that may cause the second electronic device to send the data packet reception status report to the first electronic device. For example, identification information for identifying the data packets, such as a sequence number (SN) for identifying the data packets or a count value for identifying a transmission order of the data packets, may be included in the trigger information to cause the second electronic device to return a reception status of the corresponding data packet. In this way, the sending side can know a transmission status of a specified data packet. For example, for important data packets, identification information of important data packets that need to be paged may be carried in the trigger information.

The trigger information may be included in a header of a data packet to be transmitted or may separately form a data packet for querying the status. As an embodiment, the PDU is controlled via the PDCP layer with a newly introduced query function.

In some possible embodiments, step S300 further includes: sending indication information to the second electronic device, where the indication information is configured to indicate a range of the data packets.

To obtain the data packet reception status report from the second electronic device, indication information may be sent to the second electronic device. The indication information is configured to indicate a range of the data packets for obtaining the sending status of the data packets.

In some possible embodiments, the data packet reception status report received from the second electronic device in Step S301 is sent based on a set trigger condition.

The data packet reception status report may be sent to the first electronic device by the second electronic device, in a case that the set trigger condition is satisfied. For example, the second electronic device may be triggered to send the data packet reception status report to the first electronic device, in a case that the reordering timer of the second electronic device expired. For example, the receiving side may also trigger sending of the status report based on indication of the higher layer, and the higher layer may be a non-access stratum (NAS) or an application (APP) layer. For example, if the terminal acts as the sending side, the association relationship of the data packets may be obtained from the NAS or the APP layer by the PDCP of the terminal. For example, if the base station acts as the sending side, the association relationship of the data packets is obtained from obtained GPRS tunneling protocol user plane (GTPU) packet header.

In some possible embodiments, the data packet reception status report received from the second electronic device in step S301 is sent according to an enhancement policy.

In a case that the set trigger condition is satisfied by the second electronic device, for example, when the reordering timer expires, the data packet reception status report is first sent to the first electronic device; then, a first variable RX-DELIV and a second variable RX-Record are updated. So that next reordering timing is initiated when the reordering timer expires.

In the related art or prior art, the first variable RX-DELIV and the second variable RX-Record are updated first, and at this time, data packets before the first variable RX-DELIV (i.e., data packets with sequence number values less than RX-DELIV) are determined as successfully received data packets. Whereas the existing status report only reflects the reception status of the data packets with sequence numbers greater than or equal to RX-DELIV. In this case, the first electronic device cannot know the true situation whether the data packets are successfully received by the second electronic device. In the example of the present disclosure, the data packet reception status report is first sent to the first electronic device, and the first variable RX-DELIV and the second variable RX-Record are then updated, so that the first electronic device can accurately know whether the data packets are successfully received by the second electronic device. If the status report is triggered at this time, for example, the reordering timer expires, the reception of the data packets before the first variable RX-DELIV may be informed first.

In another embodiment, the set trigger condition is satisfied by the second electronic device, for example, the reordering timer expires, the first variable RX-DELIV and the second variable RX-Record may also be updated according to an existing procedure. However, when the status report is triggered, it should be possible to send the reception status of the data packets before sending RX-DELIV to the first electronic device.

In an example of the present disclosure, by considering the association relationship that may exist between the continuously transceived data packets, a method for sending the data packets is provided. The method is performed by the first electronic device and includes:
discarding, in a case that a discard timer expired, a data packet corresponding to the discard timer and a data packet having an association relationship with the data packet corresponding to the discard timer in the process of sending the data packets to the second electronic device.

In the process of sending the data packets, the discard timer can be set for each data packet, for example, timing starts when data starts to be sent, and when a feedback of reception success is not received after a preset time period, the discard timer expires. In a case that the discard timer expired, the data packet corresponding to the discard timer and data packet having the association relationship with the data packet corresponding to the discard timer are discarded.

The discard timer can be set according to a packet delay budget (PDB) or a packet set delay budget (PSDB). The parameter may be obtained in advance through a core network, configured for the base station or may be notified to the terminal in advance by the base station.

In some possible embodiments, before discarding the data packet corresponding to the discard timer and the data packet having the association relationship with the data packet corresponding to the discard timer, the method further includes obtaining an association relationship between different data packets.

In some possible embodiments, the association relationship of data packets to be sent may be obtained from the NAS or the application layer by the PDCP layer of the first electronic device.

In other possible embodiments, the association relationship of the data packets to be sent may be obtained from an aggregated packet header of a GTPU packet by the PDCP layer of the first electronic device.

The first electronic device may be the base station or a terminal device.

For example, in a packet set, the sequence numbers of the data packets include 0 to 7, and when it is determined that a data packet with sequence number 0 failed to be sent in the process of sending the data packets, all other data packets with sequence numbers 1 to 7 in the packet set are discarded and do not need to be further transmitted.

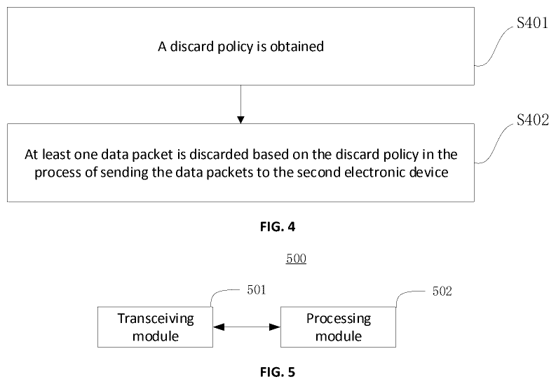

In an example of the present disclosure, by considering the association relationship that may exist between the continuously transceived data packets, a method for sending the data packets is provided. The method is performed by the first electronic device and as shown in FIG. 4, the method includes:
step S401, a discard policy is obtained.
Step S402, at least one data packet is discarded based on the discard policy in the process of sending the data packets to the second electronic device.

In some possible embodiments, in step S401, the discard policy is received from the base station device by a first user equipment, where the discard policy is received from a core network device by the base station device.

In some possible embodiments, in the step S402, discarding the at least one data packet based on the discard policy includes: for any data packet, determining whether to discard the any data packet based on the discard policy.

In one example, the discard policy includes: discarding a packet set in a case that an important data packet in the packet set failed to be transmitted, or it also can be referred to as discarding all data packets in the packet set.

For example, in a video service, a data packet in the packet set having a first type data frame, such as an I-frame, is the important data packet. If the data packet having the I-frame failed to be transmitted, the packet set is discarded.

In another example, the discard policy includes: discarding a packet set in a case that a proportion of data packets that failed to be transmitted in the packet set reaches a first set threshold, or it also can be referred to as discarding all data packets in the packet set.

For example, in a case that a packet set includes X data packets, if Y data packets or 80% of the data packets failed to be transmitted, then the packet set is discarded, or it also can be referred to as discarding all data packets in the packet set.

In another example, the discard policy includes: discarding a packet set in a case that the important data packet in the packet set failed to be transmitted and the proportion of data packets that failed to be transmitted reaches a second set threshold, or it also can be referred to as discarding all data packets in the packet set.

In another example, the discard policy includes: not discarding a data packet associated with the data packet that failed to be transmitted.

For example, if any data packet in the packet set failed to be transmitted, other data packet associated with the data that failed to be transmitted in the packet set is not be affected, i.e., the other data packet associated with the data that failed to be transmitted in the packet set is not be discarded.

In another example, the discard policy includes: not discarding a data packet even if the data packet failed to be received based on a status report of another side until a status report that the data packet is transmitted successfully is subsequently received from the another side. The advantage is as follows: in some scenarios, the important data packet can be used for decoding of subsequent data packets even if the transmission times out.

In another example, the discard policy includes: discarding a packet set in a case that the transmission of the important data packet in the packet set times out, or it also can be referred to as discarding all data packets in the packet set.

For example, in the video service, sending of the data packet in the packet set having the first type data frame, such as the I-frame times out, and if sending of the data packet having the I-frame times out, the packet set is discarded.

In another example, the discard policy includes: discarding a packet set in a case that the proportion of data packets in the packet set of which the transmission times out reaches a third set threshold.

For example, in a case that the packet set includes X data packets, if transmission of Y data packets or 80% of the data packets times out, then the packet set is discarded, or it also can be referred to as discarding all data packets in the packet set.

In another example, the discard policy includes: discarding a packet set, in a case that the transmission of the important data packet in the packet set times out and the proportion of the data packets of which the transmission times out reaches a fourth set threshold, or it also can be referred to as discarding all data packets in the packet set.

In another example, the discard policy includes: not discarding a data packet associated with the data packets of which the transmission times out.

In another example, the discard policy includes: not discarding at least one of a data packet or the data packet associated with the data packets of which the transmission times out even if the discard timer for the data packet times out until the status report that the data packet is transmitted successfully is received from the another side. The advantage is as follows: in some scenarios, the important data packet can be used for decoding of subsequent data packets even if the transmission times out.

In another example, the discard policy includes: not discarding the data packet even if the discard timer for the data packet times out until the status report that the data packet is transmitted successfully is received from the another side. The advantage is as follows: in some scenarios, the important data packet can be used for decoding of subsequent data packets even if the transmission times out.

For example, if transmission of any data packet in the packet set times out, other data packet associated with the data that failed to be transmitted in the packet set is not be affected, i.e., the other data packet associated with the data that failed to be transmitted in the packet set is not be discarded.

The discard policy may be obtained in advance through the core network, configured for the base station or may be notified to the terminal in advance by the base station. Or the discard policy is obtained from the NAS or APP layer by the terminal.

Based on the same concept as the above method embodiment, a communication device is further provided in an embodiment of the present disclosure. The communication device can have the functions of the first electronic device in the above method embodiment, and is configured to perform the steps performed by the first electronic device provided in the above embodiment. The functions may be implemented by hardware or by software or hardware executing corresponding software. The hardware or software includes one or more modules corresponding to the functions described above.

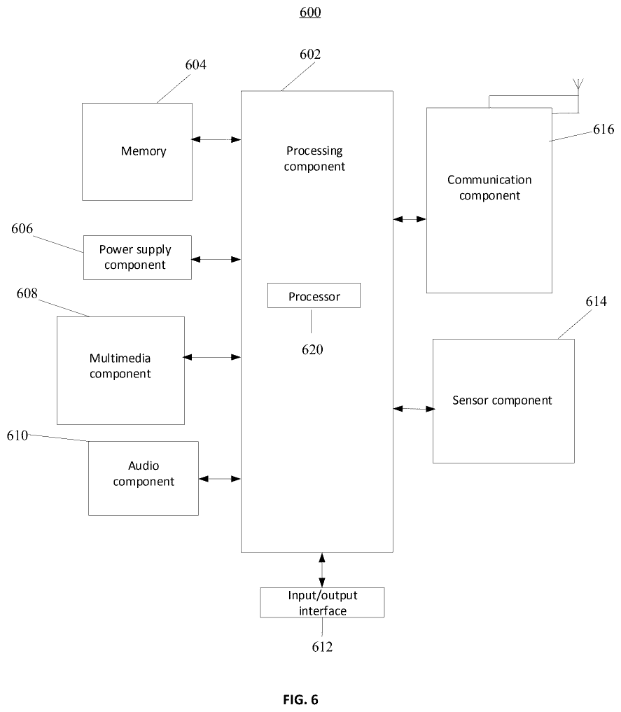

In one possible implementation, a communication device 500 as shown in FIG. 5 can be the first electronic device involved in the above method embodiments and performs the steps performed by the first electronic device in one of the above method embodiments.

The communication device 500 includes a processing module 502, or includes a transceiving module 501 and a processing module 502.

In some possible implementations, the processing module 502 is further configured to at least one of: discard a data packet that failed to be sent to a second electronic device, or discard a data packet that has an association relationship with the data packet that failed to be sent to the second electronic device.

In some possible implementations, the processing module 502 is further configured to obtain the data packet that failed to be sent to the second electronic device, based on a data packet status report obtained from a physical layer of the first electronic device.

In some possible implementations, the transceiving module 501 is further configured to receive the data packet status report from the second electronic device; and
the processing module 502 is further configured to obtain the data packet that failed to be sent to the second electronic device, based on the data packet status report received from the second electronic device.

In some possible implementations, the transceiving module 501 is further configured to send trigger information to the second electronic device, where the trigger information is configured to trigger the second electronic device to send the data packet status report to the first electronic device.

In some possible implementations, the transceiving module 501 is further configured to send indication information to the second electronic device, where the indication information is configured to indicate a range of the data packets.

In some possible embodiments, the data packet status report received from the second electronic device is sent based on a set trigger condition.

In some possible embodiments, the data packet status report received from the second electronic device is sent according to an enhancement policy.

In some possible implementations, the processing module 502 is further configured to, discard, in a case that a discard timer expired, a data packet corresponding to the discard timer and a data packet having an association relationship with the data packet corresponding to the discard timer.

In some possible embodiments, the processing module 502 is further configured to obtain an association relationship between different data packets.

In some possible implementations, the processing module 502 is further configured to obtain a discard policy; and discard at least one data packet according to the discard policy.

In a case that the communication device is the user equipment, its structure may also be as shown in FIG. 6.

FIG. 6 is a block diagram of an electronic device 600 according to an example. For example, the electronic device 600 may be a mobile phone, a computer, a digital broadcast terminal, a messaging device, a game console, a tablet device, a medical device, a fitness device, a personal digital assistant, or the like.

Referring to FIG. 6, the electronic device 600 may include one or more of: a processing component 602, a memory 604, a power supply component 606, a multimedia component 608, an audio component 610, an input/output (I/O) interface 612, a sensor component 614, and a communications component 616.

The processing component 602 generally controls overall operations of the electronic device 600, such as operations associated with displays, phone calls, data communications, camera operations, and recording operations. The processing component 602 may include one or more processors 620 to execute instructions to perform all or part of the steps of the above method. Additionally, the processing component 602 may include one or more modules that facilitate interaction between the processing component 602 and other components. For example, the processing component 602 may include a multimedia module to facilitate interaction between the multimedia component 608 and the processing component 602.

The memory 604 is configured to store various types of data to support the operations on the electronic device 600. Examples of such data include instructions for any application or method operating on the electronic device 600, contact data, phonebook data, messages, pictures, videos, etc. The memory 604 may be implemented by any type of volatile or non-volatile storage devices or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 606 provides power for various components of the electronic device 600. The power supply component 606 may include a power management system, one or more power sources, and other components associated with generating, managing, and distributing power for the electronic device 600.

The multimedia component 608 includes a screen that provides an output interface between the electronic device 600 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touches, slides, and gestures on the touch panel. The touch sensor may not only sense boundaries of a touch or slide action, but also detect duration and pressure associated with the touch or slide action. In some embodiments, the multimedia component 608 includes a front camera and/or a rear camera. When the electronic device 600 is in an operating mode, such as a shooting mode or a video mode, the front camera and/or the rear camera may receive external multimedia data. Each front camera and each rear camera may be a fixed optical lens system or have a focal length and optical zoom capability.

The audio component 610 is configured to output and/or input audio signals. For example, the audio component 610 includes a microphone (MIC) configured to receive external audio signals when the electronic device 600 is in an operating mode, such as a call mode, a recording mode, and a voice recognition mode. The received audio signals may be further stored in the memory 604 or transmitted via the communication component 616. In some embodiments, the audio component 610 further includes a speaker configured to output audio signals.

The I/O interface 612 provides an interface between the processing component 602 and a peripheral interface module, and the peripheral interface module may be a keyboard, a click wheel, a button, or the like. These buttons may include, but are not limited to, a homepage button, a volume button, a start button, and a lock button.

The sensor component 614 includes one or more sensors for providing various aspects of state evaluation for the electronic device 600. For example, the sensor component 614 may detect an open/closed state of the electronic device 600, and relative positioning of the components, such as a display and a keypad of the electronic device 600, and may also detect changes in the position of the electronic device 600 or a component of the electronic device 600, the presence or absence of user contact with the electronic device 600, the orientation or acceleration/deceleration of the electronic device 600, and changes in the temperature of the electronic device 600. The sensor component 614 may include a proximity sensor configured to detect the presence of a nearby object in the absence of any physical contact. The sensor component 614 may also include a light sensor, such as a CMOS or CCD image sensor, for use in imaging applications. In some embodiments, the sensor component 614 may also include an acceleration sensor, a gyro sensor, a magnetic sensor, a pressure sensor, or a temperature sensor.

The communication component 616 is configured to facilitate wired or wireless communication between the electronic device 600 and other devices. The electronic device 600 may access a wireless network based on a communication standard, such as WiFi, 4G, or 5G, or a combination of them. In an example, the communication component 616 receives a broadcast signal or broadcast related information from an external broadcast management system via a broadcast channel. In an example, the communication component 616 further includes a near field communication (NFC) module to facilitate short range communication. For example, the NFC module may be implemented based on a radio frequency identification (RFID) technology, an infrared data association (IrDA) technology, an ultra wide band (UWB) technology, a Bluetooth (BT) technology, and other technologies.

In an example, the electronic device 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for performing the methods described above.

In an example, a non-transitory computer-readable storage medium including instructions, such as a memory 604 including instructions, is also provided, and the instructions may be executed by one or more processors 620 of the electronic device 600 to collectively perform the methods described above. For example, the non-transitory computer-readable storage medium may be an ROM, a random access memory (RAM), a CD-ROM, a magnetic tape, a floppy disk, an optical data storage device, or the like.

As used herein, the term processor may refer to one processor that performs the defined functions or a plurality of processors that collectively perform defined functions, such that the execution of the individual defined functions may be divided amongst such processors.

Other implementations of the embodiments of the present disclosure will be readily conceived by those skilled in the art after taking into account the description and practicing the present disclosure disclosed here. The present disclosure is intended to cover any variations, uses, or adaptive changes of the embodiments of the present disclosure following the general principles of the embodiments of the present disclosure and including the common general knowledge or conventional technical means in the art, which is not disclosed in the present disclosure. The description and the embodiments are considered as an example only, and the true scope and spirit of the embodiments of the present disclosure are indicated by the following claims.

It should be understood that the embodiments of the present disclosure are not limited to the precise structures that have been described above and illustrated in the accompanying drawings, and that various modifications and changes may be made without departing from the scope of the present disclosure. The scope of the embodiments of the present disclosure is limited only by the appended claims.

### Industrial Applicability

Invalid sending of data packets or invalid processing of received data by the receiving end may be avoided, and the processing efficiency of data packet sending is improved.

1. A method for sending data packets, performed by a first electronic device, the method comprising:
discarding at least one data packet in a process of sending the data packets to a second electronic device.

2. The method according to claim 1, wherein discarding the at least one data packet comprises at least one of the following:
discarding a data packet that failed to be sent to the second electronic device; or
discarding a data packet that has an association relationship with the data packet that failed to be sent to the second electronic device.

3. The method according to claim 2, wherein the method further comprises:
obtaining the data packet that failed to be sent to the second electronic device, based on a data packet status report obtained from a physical layer of the first electronic device.

4. The method according to claim 2, wherein the method further comprises:
obtaining the data packet that failed to be sent to the second electronic device, based on a data packet status report received from the second electronic device.

5. The method according to claim 4, wherein the method further comprises:
sending trigger information to the second electronic device, wherein the trigger information is configured to trigger the second electronic device to send the data packet status report to the first electronic device.

6. The method according to claim 5, wherein the method further comprises:
sending indication information to the second electronic device, wherein the indication information is configured to indicate a range of the data packets.

7. The method according to claim 4, wherein the data packet status report received from the second electronic device is sent based on a set trigger condition.

8. The method according to claim 4, wherein the data packet status report received from the second electronic device is sent based on an enhancement policy.

9. The method according to claim 1, wherein discarding the at least one data packet comprises:
discarding, in a case that a discard timer expired, a data packet corresponding to the discard timer and a data packet having an association relationship with the data packet corresponding to the discard timer.

10. The method according to claim 2, wherein the method further comprises:
obtaining an association relationship between different data packets.

11. The method according to claim 2, wherein the method further comprises:
obtaining a discard policy; and
discarding the at least one data packet comprises: discarding the at least one data packet based on the discard policy.

12. (canceled)

13. An electronic device, comprising one or more processors and a memory, wherein
the memory is configured to store a computer program; and
the computer program, when collectively executed by the one or more processors, causes the one or more processors to:
discard at least one data packet in a process of sending data packets to a second electronic device.

14. A non-transitory computer-readable storage medium storing instructions, wherein the instructions, when executed by a computer, cause the computer to:
discard at least one data packet in a process of sending data packets to a second electronic device.

15. The electronic device according to claim 13, wherein the one or more processors are further collectively configured to perform at least one of the following:
discard a data packet that failed to be sent to the second electronic device; or
discard a data packet that has an association relationship with the data packet that failed to be sent to the second electronic device.

16. The electronic device according to claim 15, wherein the one or more processors are further collectively configured to:
obtain the data packet that failed to be sent to the second electronic device, based on a data packet status report obtained from a physical layer of the electronic device.

17. The electronic device according to claim 15, wherein the one or more processors are further collectively configured to:
obtain the data packet that failed to be sent to the second electronic device, based on a data packet status report received from the second electronic device.

18. The electronic device according to claim 17, wherein the one or more processors are further collectively configured to:
send trigger information to the second electronic device, wherein the trigger information is configured to trigger the second electronic device to send the data packet status report to the electronic device.

19. The electronic device according to claim 18, wherein the one or more processors are further collectively configured to:
send indication information to the second electronic device, wherein the indication information is configured to indicate a range of the data packets.

20. The electronic device according to claim 13, wherein the one or more processors are further collectively configured to:
discard, in a case that a discard timer expired, a data packet corresponding to the discard timer and a data packet having an association relationship with the data packet corresponding to the discard timer.

21. The electronic device according to claim 15, wherein the one or more processors are further collectively configured to:
obtain an association relationship between different data packets.
